(19) United States
(12) Patent Application Publication
(10) Pub. No.: US 2010/0323072 A1
(43) Pub. Date: Dec. 23, 2010

(54) ANTIMICROBIAL TREATMENT SYSTEM AND METHOD FOR FOOD PROCESSING

(76) Inventors: Donald Bernstein, Clarks Summit, PA (US); Marc Bernstein, Clarks Summit, PA (US); Michael Bernstein, Clarks Summit, PA (US); Thomas Lonczynski, Drums, PA (US); James L. Marsden, Manhattan, KS (US); John Mekilo, Taylor, PA (US); Timothy Michalesko, White Haven, PA (US); Kurt Sorensen, Clarks Summit, PA (US)

Correspondence Address: DUANE MORRIS LLP - Allentown, 30 SOUTH 17TH STREET, PHILADELPHIA, PA, 19103-4196, US

(21) Appl. No.: 12/487,953

(22) Filed: Jun. 19, 2009

(51) Int. Cl. A23B 4/16; A23B 4/015; A23B 4/00

(52) U.S. Cl. 426/235; 99/516

(57) ABSTRACT

A system and method for reducing microbial populations on food products in a food processing facility. One embodiment provides a combination of interventions including a liquid antimicrobial treatment station that wets a food product with an antimicrobial solution containing at least one antimicrobial agent and a gaseous antimicrobial treatment station that generates and exposes the wetted food product to advanced oxidative gaseous environment. A transport system is provided for transporting the food product between the first and second treatment stations. In one embodiment, the advanced oxidative gases may be generated by plurality of photohydroionization cells. In one embodiment, the system and method may be used in a meat processing facility.

### FIELD OF INVENTION

The present invention relates to food processing, and more particularly to an antimicrobial treatment system and method suitable for use on food products.

### BACKGROUND OF THE INVENTION

Various antimicrobial treatments and decontamination approaches are used in commercial food processing applications to reduce microbial populations that may be present on the surface of food products. One such treatment commonly used in commercial food processing involves the application of liquid or aqueous antimicrobial solutions to the food product. These antimicrobial solutions have been used on many food products including, but not limited to meat including poultry, seafood, ready-to-eat (RTE) meat-based products, and fruits and vegetables in order to comply with USDA and FDA HACCP (Hazard Analysis and Critical Control Point) programs and regulations that promote food safety.

Some antimicrobial agents that have been used in these treatment solutions as food processing aids include lactic acid, peracetic acid, citric acid, acetic acid, acidified copper sulfate, acidified calcium sulfate, chlorine based compounds such as acidified sodium chlorite (ASC), and various others. ASC, for example, has been widely used in the meat processing industry as an antimicrobial intervention. The foregoing antimicrobial agents, and others, are approved as food additives by the FDA and classified as “antimicrobials” by the USDA Food Safety and Inspection Service (FSIS) in FSIS Directive 7120.1. These antimicrobial agents are typically diluted with water to form an aqueous solution that is applied directly onto the surface of the food products being processed by either spray, deluge, or dip methods depending on the type and form of the food product.

The foregoing liquid antimicrobial solutions are intended to reduce or eliminate microbial populations occurring on the surface of the food products, including enteric bacterial pathogens such as Salmonella, Listeria, and Escherichia coli. These and other microbes are associated with causing foodborne diseases in humans and animals. Although these antimicrobial solutions have been generally effective at reducing the incidence of foodborne illnesses, especially when combined with adherence to proper food handling and preparation techniques prescribed by the FDA (e.g. cooking meat and poultry products to effective internal temperatures that kill pathogens), the need exists for further improvements that can inactivate bacteria, viruses, yeast, and mold on the surfaces of food products.

An improved system and method is therefore desired for reducing surface microbial populations on food products.

### SUMMARY OF INVENTION

The present invention provides a system and method for controlling microbiological contamination of food products that incorporates multiple antimicrobial treatment approaches. Advantageously, the system and method combines both wet/liquid and gaseous antimicrobial treatments to reduce microbial surface populations occurring on food products, thereby decreasing the risk of foodborne-related illnesses when contaminated food products are ingested. Such microbes or microorganisms includes bacterial pathogens such as E. coli, Salmonella, and Listeria.

In one embodiment, a combination liquid and gaseous antimicrobial treatment system for decontaminating food products includes a first liquid antimicrobial treatment station wetting a food product with an antimicrobial solution containing at least one antimicrobial agent, a second gaseous antimicrobial treatment station exposing the wetted food product to advanced oxidative gases, and a transport system operable to transport the food product between the first treatment station and the second treatment station. In one embodiment, the advanced oxidative gases are generated by a plurality of photohydroionization cells. The photohydroionization cells comprise an ultraviolet light source and multi-metallic catalytic target containing a hydrophilic material. The target is activated by ultraviolet energy from the photohydroionization cells causing chemical reactions which generate an oxidative environment. In one embodiment, the oxidative environment includes advanced oxidation gases such as ozone, Hydroxyl Radicals, Super Oxide Ions, Ozonide Ions, Hydroxides, and Hydro Peroxide. In a preferred embodiment, the food product comprises meat trimmings.

In another embodiment, a combination liquid and gaseous antimicrobial treatment system for decontaminating meat products includes a first liquid antimicrobial treatment station comprising an application apparatus operative to apply an antimicrobial solution to a meat product. Preferably, the solution contains at least one antimicrobial agent. A second gaseous antimicrobial treatment station is provided comprising a light panel that includes a plurality of hydroionization cells operative to generate oxidative gases. In one embodiment, the hydroionization cells include a germicidal ultraviolet light source and a multi-metallic catalytic target comprising more than one type of metal. A transport system is provided that is configured and arranged to transport the meat product from the first treatment station to the second treatment station.

According to yet another embodiment of the present invention, a ground meat processing system with combined liquid and gaseous antimicrobial interventions is provided. The system includes a first liquid antimicrobial treatment station adapted to apply an antimicrobial solution comprising an antimicrobial agent to a meat product comprised of meat trimmings having a first size. The system further includes a first meat shredding or grinding apparatus which is operable to reduce the size of the meat trimmings to define a first ground bulk meat product. Further provided with the system is a second gaseous antimicrobial treatment station comprising a plurality of photohydroionization cells which are operable to generate ultraviolet light and advanced oxidative gases, and a transport system operable to transport the meat product through the first and second treatment stations. The photohydroionization cells are preferably positioned and arranged with respect to the transport system to expose the first bulk meat product to the ultraviolet light and advanced oxidative gases for inactivating microbes that may be present on the surface of the meat product.

According to another embodiment of the present invention, a method for reducing microbial populations on food products by combining liquid and gaseous antimicrobial treatments is provided. The method preferably includes applying a first aqueous solution comprising an antimicrobial agent to a food product, energizing a germicidal ultraviolet light source proximate the food product, and forming a gaseous antimicrobial oxidative environment near the food product. The oxidative environment and ultraviolet light are operable to inactivate microbes on the surface of the food product.

According to yet another embodiment of the present invention, a method for reducing microbial populations on ground meat products by combining liquid and gaseous antimicrobial treatments includes applying a first aqueous solution comprising an antimicrobial agent to meat trimmings, reducing the size of the meat trimmings to define a first ground bulk meat product, energizing a plurality of photohydroionization cells comprising an ultraviolet light source, and forming an gaseous antimicrobial oxidative environment proximate the first ground bulk meat product for inactivating microbes on the meat product.

### BRIEF DESCRIPTION OF THE DRAWINGS

The features of several embodiments of the present invention will be described with reference to the following drawings where like elements are labeled similarly, and in which:

FIG. 1 is a process flow diagram of one exemplary antimicrobial treatment system according to the present invention;

FIG. 2 is perspective view of a UV-based photohydroionization cell usable in the treatment system of FIG. 1;

FIG. 3 is a table showing results of a trial application of the antimicrobial treatment system of FIG. 1;

FIG. 4 is a perspective view of a gaseous advanced oxidation antimicrobial treatment apparatus according to the present invention; and

FIG. 5 is a perspective view of a light panel usable in the apparatus of FIG. 4 including a plurality of the UV-based photohydroionization cells of FIG. 2.

All drawings are schematic and not drawn to scale.

### DETAILED DESCRIPTION OF THE INVENTION

In the description of particular embodiments of the present invention disclosed herein, any reference to direction or orientation is merely intended for convenience of description and is not intended in any way to limit the scope of the present invention. Although the features and benefits of the invention are illustrated by reference to particular embodiments, the invention expressly should not be limited to such embodiments illustrating some possible but non-limiting combination of features that may be provided alone or in other combinations of features. The scope of the invention is defined by the appended claims, and not limited to the description or embodiments provided herein.

As the terms are used herein, “food product or material” broadly includes any type of single or combination of foods that may be ingested by a human being or animal. The term “meat” as used herein shall broadly be defined as intact or non-intact flesh from any type or combination of animals including but not limited to as examples beef, pork, lamb, wild game, poultry, seafood, etc.

The present invention provides a system and method for controlling microbiological contamination of food products that preferably combines both a liquid/wet and a gaseous antimicrobial intervention or treatment. In a preferred embodiment, the gaseous antimicrobial treatment involves application of an advanced oxidation process such as Photohydroionization™ (PHI) that produces a gaseous oxidizing environment proximate to the food product, as further described herein.

In one embodiment, the first wet or liquid portion of the present antimicrobial treatment process involves applying an aqueous solution containing a conventional antimicrobial agent onto the surface of the food product where microorganisms may be present. Contacting the food product with the antimicrobial solution is intended to inactivate the microbiological contaminants that may be present to concomitantly decrease the risk of foodborne illnesses.

The antimicrobial solution may be applied by any conventional means used in the art such as spraying, deluging, or immersion (dipping) as will be readily known to those skilled in the art. The type of wet/liquid application used will depend on factors such as the type, size, and shape (e.g. regular or irregular) of the food product. Spraying or spray washing is one of the most common application techniques used for applying antimicrobial solution to a food product. The antimicrobial solution spray is typically applied automatically via a spray cabinet or enclosure that includes piping headers fitted with multiple spray nozzles. The performance of such spray systems for reducing microbial populations is based on such factors as flow rate, spray pattern, and food product shape, size, and speed through the spray system.

Deluge systems are somewhat similar to spray systems, but generally deliver a higher rate of flow and quantity of the antimicrobial solution to the food product. The effect is analogous to a waterfall in that the food product is drenched with antimicrobial solution.

Immersion or dip systems typically include a treatment basin or tub that holds the antimicrobial solution. The food product is immersed and removed from the solution, which in some embodiments may be recirculated through the basin. The immersion technique is generally limited to smaller food products such as various cuts of meat, poultry carcasses, or other products where complete immersion will not adversely affect the quality of the food product.

It is well within the ambit of those skilled in the art to select the proper type of the foregoing wet/liquid antimicrobial solution treatment system for a given food decontamination application, especially as many of these are commercially-available as complete systems from various manufacturers.

Any suitable FDA-approved antimicrobial agent, such as the chemical and compound “antimicrobials” listed in FSIS in Directive 7120.1, may be used to prepare the treatment solution used for the wet/liquid portion of the antimicrobial treatment system described herein. The type of antimicrobial agent selected will be dictated in part by the type and form of the food product being processed and treated. In one preferred embodiment, the antimicrobial used without limitation may be acidified sodium chlorite (ASC).

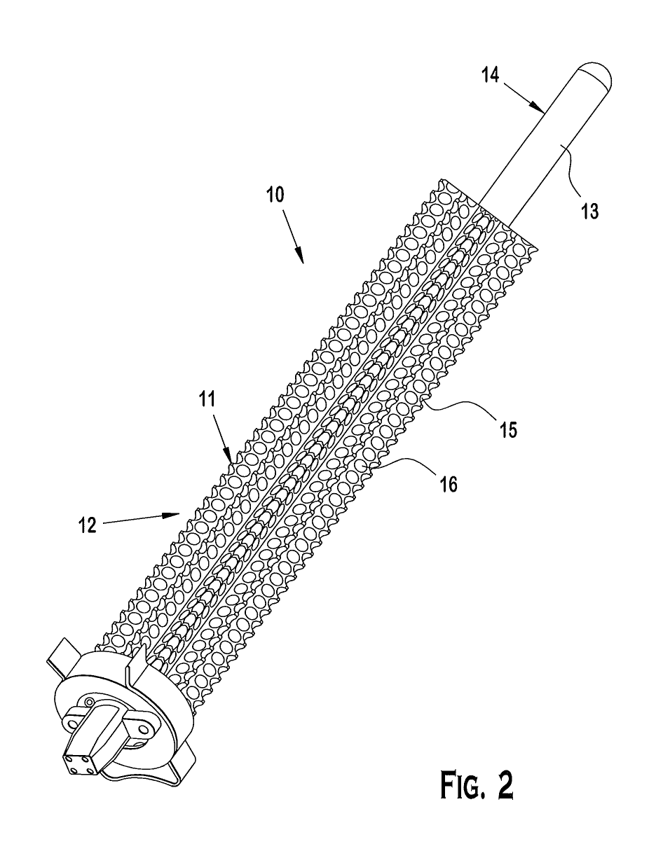

The second gaseous portion of the antimicrobial treatment process according to the present invention preferably uses an advanced oxidation gas generator such as described in U.S. Patent Application Publication US 2005/0186124 to Fink et al., which is incorporated herein by reference in its entirety. Referring to FIG. 2 (excerpted from US 2005/0186124), the advanced oxidation generator may be a commercially-available UV-based Photohydroionization™ or PHI Cell 10 obtainable from RGF Environmental Group, Inc. of West Palm Beach, Fla. The PHI Cell 10 incorporates a broad spectrum high intensity ultraviolet light source 14 (100-300 nm) that is targeted onto a proximately-located multi-metallic catalytic surface 11 of a generally annular catalytic target 12 surrounding the UV light source. Ultraviolet light source 14 in one embodiment is delivered by germicidal ultraviolet light elements 13 concentrically positioned inside target 12.

Referring to FIG. 2 (wherein a portion of catalytic target 12 is removed to show light source 14), the catalytic surface 11 of catalytic target 12 is comprised of a multi-metallic catalytic and hydrophilic material. The hydrophilic material incorporated into surface 11 of target 12 absorbs ambient moisture from the surrounding air in the environment near the food product. In a preferred embodiment, this moisture is advantageously contributed at least in part by first treating the food product with a liquid antimicrobial solution as described herein prior to the advanced oxidation gaseous treatment station. Some exemplary hydrophilic materials that may be used include silica gels such as tetraalkoxysilanes TMOS, tetramethoxysilane, or tetraethoxysilane (TEOS). Other suitable hydrophilic materials capable of attracting and absorbing ambient water moisture may be used.

Referring to FIG. 2, the multi-metallic materials used in catalytic surface 11 of catalytic target 12 in some embodiments preferably include titanium dioxide (TiO₂), copper metal (Cu), silver metal (Ag), and Rhodium (Rh) which yield the advanced oxidation gases farther described herein.

With continuing reference to FIG. 2, catalytic target 12 is preferably an open-latticed structure having alternating closed areas 15 and open areas 16 to allow both passage of both the advanced oxidation gases produced near the catalytic target surface 11 of PHI Cell 10 and a portion of the ultraviolet light energy emitted from the Cell toward the food product being decontaminated. Preferably, catalytic target 12 is configured to allow for substantially maximum surface area, while limiting the angle of incidence of the ultraviolet photon energy being directed at the target structure. In some embodiments, a repeating ridged or pleated geometry may be provided for both a correct ratio of open area to closed area as well as maximizing the surface area of the catalytic target 12 that will be exposed for reacting with the ultraviolet light energy and the surrounding environment. Any suitable geometry having a combination of closed and open areas, however, may be used that increases available surface area for the hydrophilic catalytic material to react with the ultraviolet light energy and the surrounding gases. In one exemplary embodiment, catalytic target 12 may have approximately 50% closed active catalytic surface 11 areas and 50% open areas that allow the ultraviolet photon energy to pass out of the target for promoting additional reactions external to the PHI Cell 10. Depending on the particular intended application, catalytic target 12 can vary between 0% (a flow thru cell) and 95% open area, with a preferred open area percentage being between 40% and 60% open area.

With continuing reference to FIG. 2, the advanced oxidation process is activated when the ultraviolet light source 14 strikes the catalytic surface 11 of the target 12 and energizes the atmosphere surrounding light source which preferably is positioned in the environment proximate to the food product being treated. The broad spectrum ultraviolet light element 13 preferably produces two bands of ultraviolet light frequencies at approximately 185 nm and 254 nm wavelengths. The ultraviolet energy at 254 nm strikes the target catalytic surface 11 and activates production of low levels of ozone, Hydroxyl Radicals, Super Oxide Ions, Ozonide Ions, Hydroxides, and Hydro Peroxide on the target surface. The ultraviolet light energy at 254 nm frequency energizes the catalytic surface 11 causing the surface to react with water molecules in the surrounding air and primarily on the hydrophilic surface causing them to split into the Hydroxyl Radicals.

The broad spectrum ultraviolet light source 10 of the PHI Cell 10 also preferably generates ultraviolet light energy emitted at 185 nm. The photon energy emitted at this wave length splits oxygen molecules to form safe low levels of ozone gas. These ozone molecules in the air are then reduced back to oxygen via a decomposition process activated by the 254 nm ultraviolet light energy also emitted from the broad spectrum germicidal ultraviolet light source 14. The 185 nm reactions similarly produce the same oxidizers as in the 254 nm reactions noted above.

The ozone and foregoing advanced oxidation gaseous compounds that include Hydroxyl Radicals, Super Oxide ions, Hydro Peroxide, etc. as antimicrobial agents that systematically inactivate bacteria, viruses, mold, yeast in the air surrounding the PHI Cell 10 and on the surface of the food product positioned proximate to Cell 10. In some embodiments, the combined germicidal effect of the UV light and advanced oxidation gases may be used in a meat or poultry processing plant to decontaminate the surfaces of meat/poultry trimmings and ground or tenderized products. Oxidizers created during this advanced oxidation processes are more effective than traditional oxidants at reacting with compounds such as microbes and other inorganic and organic chemicals. These oxidants, generally referred to as advanced oxidation products (AOP), include Ozone, Hydroxyl Radicals, Hydro Peroxides, Ozonide Ions, Hydroxides, and Super Oxide ions. All of these compounds are either used during or are produced as a result of advanced oxidation processes. Generally, advanced oxidation products will react with compounds that typically will not react with other common oxidants.

Referring briefly to FIG. 2, a plurality of PHI Cells 10 are preferably provided to decontaminate food products handled and processed in a food product processing facility as further described herein in greater detail. In some embodiments, the food products may be meat.

In a preferred embodiment, the wet or liquid and gaseous portions of the antimicrobial treatment processes are sequentially applied to the food product in series. In one preferred embodiment, the wet or liquid portion of the antimicrobial decontamination treatments is performed to the food product first before the gaseous advanced oxidation treatment station using the PHI Cells 10. This arrangement advantageously introduces moisture to the food product upstream of the PHI Cells 10 to ensure that there is adequate moisture present for completing the gaseous advance oxidation reactions.

### Example

The combination liquid/wet and gaseous antimicrobial treatment process according to the present invention was tested for reducing microbial populations on the surface of meat products. A combination treatment of beef trimmings using acidified sodium chlorite (ASC) for the liquid/wet portion of the treatment and UV-based Photohydroionization™ (PHI) advanced oxidation process employing the PHI Cells 10 described herein for the gaseous portion of the treatment was evaluated as a means of increasing the reduction of surface contamination on the beef trimmings. The combination of treatments was specifically evaluated for reducing levels of Escherichia coli O157:H7 and Salmonella spp. on the surface of inoculated beef trimmings. Trimmings were first treated using a solution of Acidified Sodium Chlorite that was applied in a spray cabinet and then subjected to treatment by oxidative gases produced by the PHI Cells 10. The microbiological population reductions associated with each treatment and the combined reductions were measured. Both the Acidified Sodium Chlorite and Advanced Oxidation technologies are considered to be processing aids and do not require labeling.

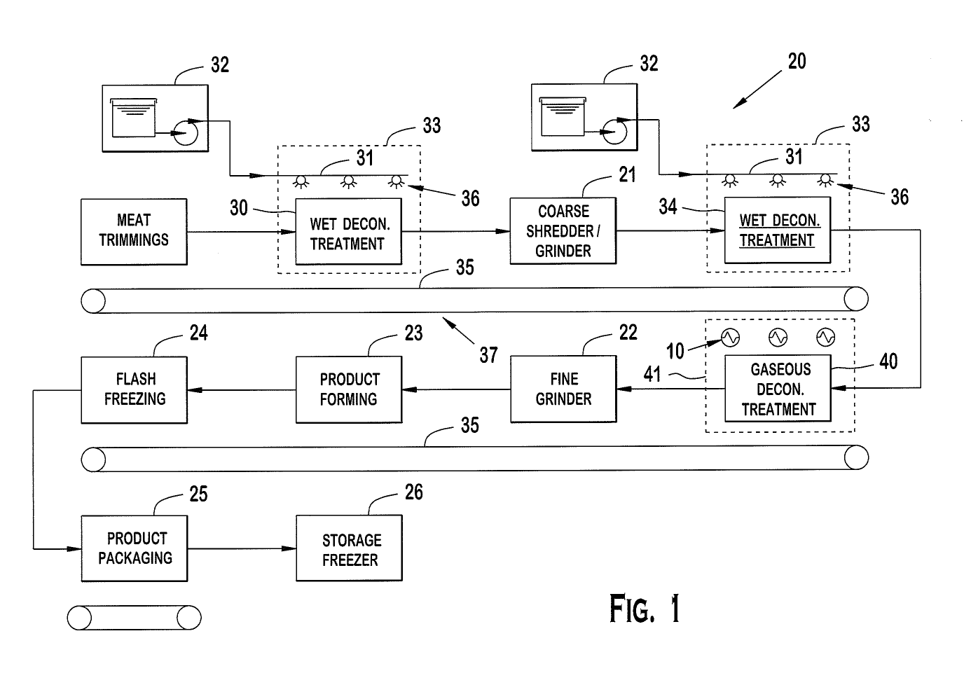

The gaseous UV-based advanced oxidation process involves a conveyor-mounted transport system in which an enclosure or tunnel (“Food Sanitation Tunnel”) is constructed around the conveyor that transports the beef trimming or other food product thereon. A plurality of the foregoing UV-based PHI Cells 10 are disposed in the Food Sanitation Tunnel, as described in more detail elsewhere herein with reference to FIGS. 1, 4, and 5.

Boneless beef trimmings were surface inoculated with a 5-strain cocktail of E. coli O157:H7 or Salmonella spp. and then treated in a spray cabinet using an Acidified Sodium Chlorite solution. The reductions associated with this treatment were measured by removing half of treated, inoculated trimmings and conducting microbiological analyses. The remaining trimmings were treated in the Food Sanitation Tunnel for periods of 0, 15, 30 and 60 seconds in order to determine the effect of the combined liquid and gaseous antimicrobial treatment. In addition, inoculated beef trimmings were treated using only the UV/PHI Food Sanitation Tunnel. This was done in order to measure the effect of the UV/PHI treatment independent of the Acidified Sodium Chlorite treatment. The target surface inoculation for all tests was 6.0 Log CFU/cm2. The actual surface inoculations achieved were 6.35 and 6.2 Log CFU/cm2 for Salmonella and E. coli O157:H7, respectively.

After each treatment and combination of treatments, the beef trimmings were tested to determine reductions of each pathogen tested. Inoculated beef trimmings were also treated with a solution of Acidified Sodium Chlorite and then ground through a coarse plate (¾″) and treated with the UV/PHI panel. This was done to simulate a commercial process that involves the sequential treatment of trimmings and coarse ground beef. Three replications were conducted for each treatment. Log CFU/cm2 reductions were calculated as the difference in log recoveries from the inoculated products prior to treatment and the log recovery after treatment.

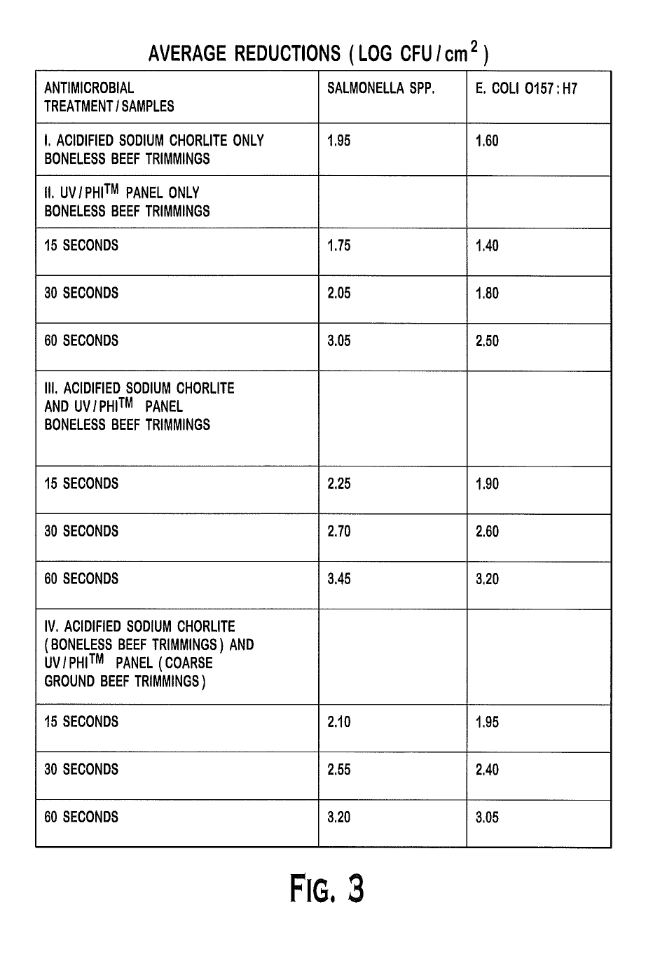

The results of this example and trial are summarized in the table appearing in FIG. 3, which show the average Log CFU/cm2 reductions achieved from the initial pathogen inoculations noted above. The results demonstrate that both the treatment with a solution of Acidified Sodium Chlorite and the treatment using the UV based PHI cell are effective interventions for controlling E. coli O157:H7 and Salmonella on the surface of beef trimmings and coarse ground beef. However, the effectiveness of both interventions is enhanced when they are combined and applied in sequence. The most effective treatment involved a spray application of Acidified Sodium Chlorite solution followed by a 60 second treatment using a UV/PHI panel. The combined reduction for this combination of treatments was 3.45 Log CFU/cm2 for Salmonella and 3.20 Log CFU/cm2 for E. coli O157:H7. The combined reductions when the Acidified Sodium Chlorite was applied to inoculated beef trimmings and the UV/PHI treatment was applied to coarse ground beef for a period of 60 seconds was 3.20 Log CFU/cm2 for Salmonella and 3.05 Log CFU/cm 2 for E. coli O157:H7. The results of this study suggest that this combination of liquid and UV-based gaseous antimicrobial treatments is a more effective means of controlling microbiological contamination on beef trimmings and in ground beef than using either treatment alone.

Controlling microbiological contamination on “intact” meat products, which are whole muscle trim or cuts of meat (e.g. steaks, roasts, and similar), is generally less problematic than “non-intact” meat products because the pathogens or microorganisms are generally confined to the surface of a product. The interior of the whole muscle trim is generally free of these contaminates.

With “non-intact” meat products, such as without limitation blade tenderized, needle-injected, or ground meat products, any surface contamination present may be translocated to the interior of the meat product during these manual or apparatus-assisted manipulations of the whole muscle trim.

A conventional approach to reducing the risk of internal contamination in tenderized or ground meat products is to reduce or eliminate surface microbial contamination on the intact meat trimmings prior to grinding or other similar manipulation. The technologies used heretofore for this purpose generally involve a wet/liquid antimicrobial treatment in many cases in which an approved antimicrobial agent in a water solution is sprayed or otherwise applied to the meat trimmings. It is generally not desirable to perform such a wet decontamination treatment after the whole meat trim has been manipulated such as tenderized or ground since the porous meat product will tend to become oversaturated with the antimicrobial liquid solution. Accordingly, antimicrobial treatments involving tenderized or ground meat products have heretofore been largely limited to decontamination prior to any grinding, tenderizing or other similar manipulation.

Embodiments of the present invention, however, advantageously permit further decontamination of non-intact meat products using the oxidizing gaseous antimicrobial treatment produced by the ultraviolet-based PHI process after the product has been at least partially manipulated and transformed to further reduce the risk of foodborne illness. Particularly for ground or tenderized meat products, treating the non-intact product with oxidizing gas after wet antimicrobial treatment of the intact whole muscle trim provides an additional measure of prevention.

FIG. 1 depicts an example of a combined wet/liquid and gaseous antimicrobial treatment process according to the present invention as applied to a commercial ground meat product processing plant. The advanced oxidation process preferably uses Photohydroionization™ or PHI Cells 10 as described in greater detail elsewhere herein.

Referring to FIG. 1, a meat processing system 20 in one embodiment may generally include, in sequence of operation, a coarse grinding or shredding apparatus 21, a fine grinding apparatus 22, product forming apparatus 23, flash freezing apparatus 24, product packaging station 25, and bulk storage freezer 26. Bulk shredding apparatus 21 provides an initial size reduction or coarse grind of the whole muscle meat trimmings T. In a representative embodiment, by example without limitation, a ¾ inch initial coarse grind may be used wherein the meat trimmings T have a larger size before being processed through shredding apparatus 21 than afterwards. Accordingly, the initial larger pieces of meat trimmings T are transformed into a plurality of smaller pieces of meat or an interim bulk meat product. Fine grinding apparatus 22 subsequently further reduces the size of the already manipulated trimmings T to the final ground size intended for the bulk meat product. Product forming apparatus 23 next receives the ground meat in final reduced size and forms the product into its final form for sale and distribution to end users. By way of example, the final form may be square or round patties in some embodiments such as in the production of hamburgers.

It will be appreciated that in some instances, the intended end product may simply be ground meat or the ground meat may be used to make a multitude of other possible meat-based raw food products (e.g. sausage, etc.) or ready-to-eat (RTE) cooked food products (e.g. hot dogs, kielbasa, deli meats, etc.). Accordingly, the product forming apparatus 23 may be omitted or replaced by one or more types of meat processing and/or packaging apparatuses depending on the intended meat end product. It will further be appreciated that other embodiments of a meat processing system 20 or other food product processing system may include additional or different processing apparatuses than shown in FIG. 1 depending on the food product being prepared. Accordingly, the food processing system is not limited by the number and types of apparatuses described herein.

The foregoing meat processing apparatuses described are conventional commercially-available equipment commonly used in the meat processing industry. It will be appreciated by those skilled in the art that various portions of the foregoing process may be accomplished manually and/or automatically.

A transport system 37 which may include a combination of manual and/or automated transport methods may be used to move the meat trimmings T or product through the meat processing system 20 from start to finish between the various apparatuses or stations that may be provided. Motor-driven conventional food conveyors 35 may preferably be used to move the meat trimmings T through a majority of the processing system 20. Conveyors 35 are commercially available and may include rolling food grade or safe belts or grates, electric motors, pulleys, idlers, controls, and other appurtenances typically furnished with such conveyors used in the food processing industry. The speed of the conveyor 35 will determine how fast or slow the food product progresses through the meat processing line and through the antimicrobial treatment stations. Manual transport means may be used to augment the automated portions of transport system 37, and includes for example purely manual and/or apparatus-assisted transport such as without limitation hand-wheeled or motorized carts, wheelbarrows, forklifts, hand-carrying, or other methods.

With continuing reference to FIG. 1, an antimicrobial treatment system is provided that advantageously includes a combination of both a wet/liquid and a gaseous antimicrobial intervention at various process points to control surface contamination on the meat products as it progresses through the meat processing system 20. The first intervention comprises a first wet/liquid antimicrobial treatment station 30 in which a solution containing an antimicrobial agent is applied to the meat trimmings T. In this embodiment, the liquid antimicrobial treatment station is preferably located near the head of the meat processing line to provide initial surface decontamination of the whole muscle trimmings T at the start of the process. This is intended to reduce any initial microbiological populations on the surface of the whole muscle trimmings T that may carry over from the carcass-processing facility and/or have developed during shipping and handling.

With continuing reference to FIG. 1, wet/liquid antimicrobial treatment station 30 in one embodiment includes an application apparatus used for applying an antimicrobial solution to the food product. In one preferred embodiment, treatment station 30 may be a deluge type system having a spray header 31 with one or more spray nozzles 36 sized and adapted to drench or flood the meat trimmings T with the antimicrobial solution. Spray header 31 may be mounted in a spray enclosure or cabinet 33 positioned over food conveyor 35. It will be appreciated that in other embodiments, depending on the type of food product being decontaminated, a spray or immersion system may be more suitable or preferred for the initial antimicrobial treatment.

In a preferred embodiment, the antimicrobial agent may be an acidified sodium chlorite (ASC), such as for example without limitation Keeper® Professional available from Bio-Cide International, Inc. of Norman, Okla. or Sanova® available from Ecolab, Inc. of St. Paul, Minn. Other suitable antimicrobial agents may be used, such as any of the FDA approved antimicrobial agents listed in FSIS Directive 7120.1. A commercially-available chemical mixing-supply system 32 may be provided to prepare the ASC solution, such as an AANE (automated, activation, non-electric) unit available from Bio-fide International, Inc. Other suitable commercial chemical mixing-supply systems may be used. Chemical mixing-supply system 32 generally includes a antimicrobial agent storage vessel, water source, supply pump, valving, and instrumentation. Mixing-supply system 32 essentially mixes the correct ratio of an antimicrobially effective quantity of the antimicrobial agent such as ASC in some embodiments with a metered amount of water to prepare the antimicrobial solution, which is then pumped to spray header 31 for application to the food product through spray nozzles 36. Preferably, the concentration of antimicrobial agent in the solution is sufficient to inactivate the microbiological contaminants coming into contact with the solution on the surface of the food product.

With continuing reference to FIG. 1, a second wet/liquid antimicrobial intervention may preferably be provided at treatment station 34. Preferably, in one embodiment, antimicrobial treatment station 34 is located downstream of coarse shredding apparatus 21 in the meat processing system 20. After shredding apparatus 21, the coarsely ground bulk meat product will have substantially more surface area where microbes may reside than the previous larger pieces of whole muscle trimmings T. Microbes not inactivated by the first antimicrobial treatment station 30 or deposited on the trimming T thereafter may be translocated to the many newly created surfaces after the coarse grind. Antimicrobial treatment station 34 advantageously provides additional surface decontamination of the bulk meat product prior to further grinding and processing.

With continuing reference to FIG. 1, antimicrobial treatment station 34 may be similar to wet/liquid treatment station 30 already described herein in some embodiments and be a deluge type system. In one embodiment, however, antimicrobial treatment station 34 may be a spray type system with spray nozzles adapted to deliver a finer spray and less antimicrobial solution to the already manipulated meat trimmings T which have been coarsely ground by shredding or grinding apparatus 21 to an interim bulk meat product. This prevents oversaturation of the ground meat product with solution. In one embodiment, therefore, treatment station 34 includes a spray header 31 and spray nozzles 36 similar to treatment station 30 with the difference being primarily in the rate of flow of antimicrobial solution that is applied to the meat trimmings T. In some embodiments where the same antimicrobial solution is applied to the meat trimmings or product at treatment stations 30 and 34, a single mixing-supply system 32 may be provided having a common spray header 31 routed through the food processing facility that supplies antimicrobial solution to two or more wet/liquid treatment stations like 30 and 34.

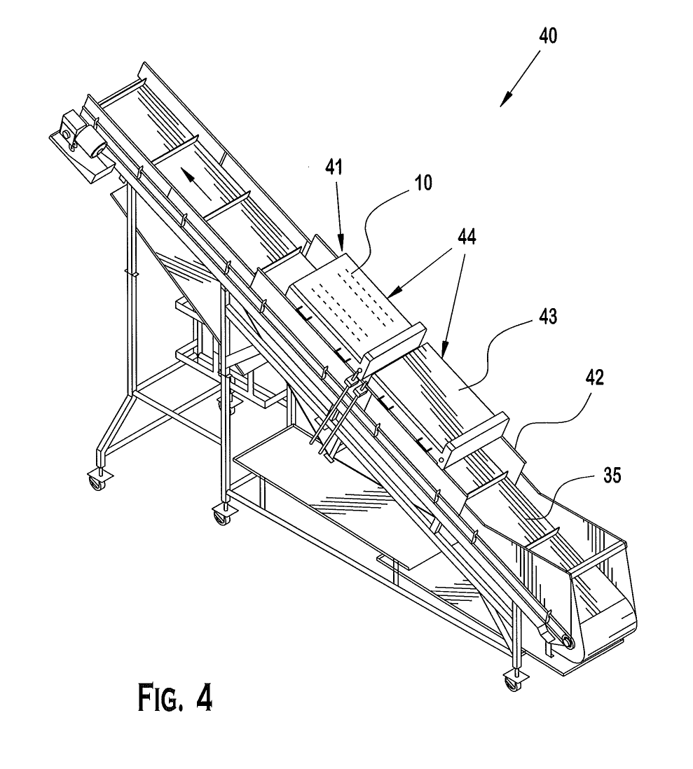

Referring to FIGS. 1, 4, and 5, a third antimicrobial intervention is provided by gaseous antimicrobial treatment station 40. Preferably, the gaseous portion of the intervention uses the UV-based Photohydroionization™ or PHI Cells 10 as already described herein. In one embodiment, shown in FIG. 4, gaseous antimicrobial treatment station 40 is positioned before or upstream of fine grinding apparatus 22 in the meat processing line, and more preferably after coarse grinding or shredding apparatus 21 but before fine grinding apparatus 22 as a final intervention before product forming.

Referring again to FIGS. 1, 4, and 5, gaseous antimicrobial treatment station 40 includes a plurality of UV-based PHI Cells 10 that are preferably disposed above and positioned proximate food conveyor 35 and the meat product transported thereon. PHI Cells 10 are preferably mounted to an enclosure or Food Sanitation Tunnel 41 that is constructed and positioned above conveyor 35. Tunnel 41 preferably extends along at least a portion of both longitudinal sides of and across the top of conveyor 35, as best shown in FIG. 4. Preferably, Food Sanitation Tunnel 41 provides a partially confined environment around conveyor 35 and the food product thereon to enhance the combined antimicrobial germicidal UV and oxidizing effects produced by the PHI Cells 10.

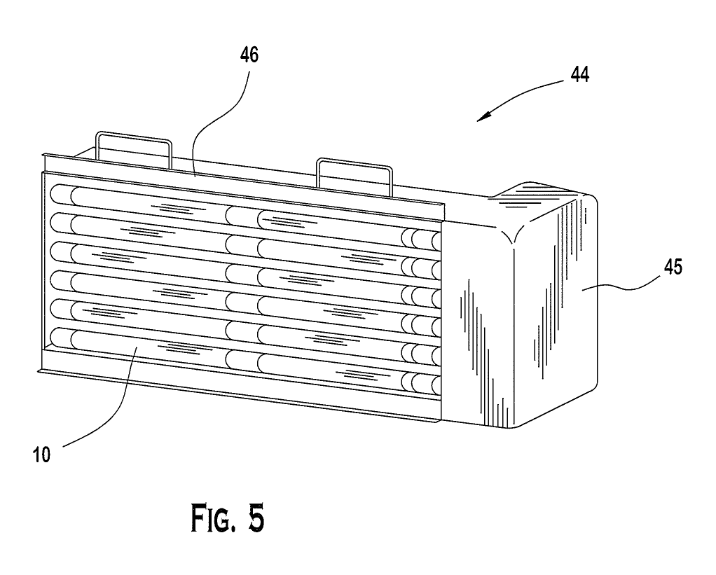

Referring to FIGS. 4 and 5, Food Sanitation Tunnel 41 in one embodiment includes two spaced apart opposing lateral sides 42 that extend along the longitudinal sides of conveyor 35 and a top 43 spanning across the two sides 42. Sides 42 may be permanently or removably mounted to the superstructure of conveyor 35 in any suitable manner known in the art. In one preferred embodiment, a plurality of PHI Cells 10 are preferably pre-mounted and incorporated into a pre-assembled UV light panel 44 having a frame 46 that may be removably fastened to lateral sides 42 of the Food Sanitation Tunnel 41 as a single unit. In one embodiment, panel 44 therefore defines the top 43 of Tunnel 41. Preferably, the plurality of PHI Cells 10 in light panel 44 are arranged and oriented such that the Cells extend in a longitudinal direction generally parallel to the length or run of conveyor 35. This allows fewer, longer PHI Cells 10 to be used for a given square footage of conveyor 35 treatment surface than if multiple shorter Cells were arranged laterally across the conveyor for a given length of conveyor. Light panel 44 may include a control-switchbox 45 which contains the electrical hook-up connections and any control circuits or devices necessary for operating the PHI Cells 10. Light panels 44 incorporating PHI Cells 10 are commercially available from RGF Environmental Group, Inc. of West Palm Beach, Fla.

Referring to FIG. 4, in one embodiment, UV light panel 44 may be pivotally attached to one of the lateral sides 42 of Food Sanitation Tunnel 41 by a hinge. This allows the light panel 44 to be swung open for maintenance to replace the UV bulbs of the PHI Cells 10 as they burn out over time. The lateral side 42 to which the light panel 44 is hingedly mounted is therefore preferably rigidly mounted to conveyor 35 and the opposite lateral side 42 in some embodiments may be removably or pivotally mounted to conveyor 35 via a hinge to allow that side to be removed or folded down to improve access to the conveyor after the light panel 44 is raised or removed.

With continuing reference to FIGS. 4 and 5, one or more PHI light panels 44 may be longitudinally mounted in series along and supported by lateral sides 42 of Food Sanitation Tunnel 41 and conveyor 35. The number of light panels 44 provided will depend upon the type, size, and shape of meat or food product being processed and operational parameters such as conveyor speed and linear length of treatment intended by the PHI Cells 10 to inactivate microbial contamination which equates to treatment period or duration of time. It is well within the ambit of those skilled in the art to determine the appropriate number and length of light panels 44 required for a given antimicrobial treatment application.

In one possible embodiment, as shown in FIGS. 4 and 5, the PHI Cells 10 are preferably arranged in parallel relationship to each other and oriented along the length or run of food conveyor 35, as already described. The PHI Cells 10 are horizontally spaced apart from each other by a suitable distance that preferably provides an overlap of the germicidal UV effect of the Cells and gaseous oxidizing environments produced by each Cell.

Preferably, the PHI Cells 10 cells are vertically spaced above conveyor 35 by a suitable distance that ensures that both the irradiating germicidal effect of the UV light produced by Cells 10 and the advanced oxidation gases also produced can substantially envelop and treat the meat (or other food) product to the greatest extent practical. In some non-limiting representative examples, PHI Cells 10 may typically be spaced from about 6 inches to about 8 inches above conveyor 35. The vertical spacing, however, will be dependent on the type of meat or food product being processed and other operational parameters such as conveyor speed, treatment time required, and type, shape, and size of the meat or food product being processed. It is well within the ambit of those skilled in the art to determine the appropriate vertical distance to mount PHI Cells 10 above the conveyor 35 that may be required for a specific food product decontamination application.

Advantageously, the gaseous antimicrobial intervention provided by UV-based PHI Cells 10 at antimicrobial treatment station 40 does not contribute any significant amount of liquid to the partially ground or otherwise manipulated meat product. Therefore, this gaseous portion of the antimicrobial treatment using advanced oxidation gases may be employed to further reduce any microbial populations that may have survived the first and second wet/liquid antimicrobial interventions at treatment stations 30 and 34 even after the coarse grinding by shredding apparatus 21.

Although the foregoing example illustrates one possible application of the combined wet/liquid and gaseous antimicrobial treatment process of the present invention in a ground meat processing plant, it will be appreciated that the present treatment system may be employed in the processing or handling of any type of food product where it is desired to reduce surface microbial populations. Accordingly, the invention is expressly not limited for use with any particular type of food product or processing.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A combination liquid and gaseous antimicrobial treatment system for decontaminating food products comprising:
a first liquid antimicrobial treatment station wetting a food product with an antimicrobial solution containing at least one antimicrobial agent;
a second gaseous antimicrobial treatment station exposing the wetted food product to advanced oxidative gases; and
a transport system operable to transport the food product between the first treatment station and the second treatment station.

2. The system of claim 1, wherein the advanced oxidative gases are generated by a plurality of photohydroionization cells.

3. The system of claim 2, wherein the photohydroionization cells comprise an ultraviolet light source and multi-metallic catalytic target positioned to receive ultraviolet energy from the light source.

4. The system of claim 3, wherein the multi-metallic catalytic target is comprised of titanium dioxide (TiO₂), copper metal (Cu), silver metal (Ag), and Rhodium (Rh).

5. The system of claim 3, wherein the ultraviolet light source produces ultraviolet light at wavelengths of approximately 185 nm and 254 nm.

6. The system of claim 1, wherein the advanced oxidation gases include ozone, Hydroxyl Radicals, Super Oxide Ions, Ozonide Ions, Hydroxides, and Hydro Peroxide.

7. The system of claim 1, wherein the food product comprises meat trimmings.

8. The system of claim 7, wherein the meat trimmings are processed through a shredding or grinding apparatus before the second gaseous antimicrobial treatment station.

9. A combination liquid and gaseous antimicrobial treatment system for decontaminating meat products comprising:
a first liquid antimicrobial treatment station comprising an application apparatus operative to apply an antimicrobial solution to a meat product, the solution containing at least one antimicrobial agent;
a second gaseous antimicrobial treatment station comprising a light panel including a plurality of hydroionization cells operative to generate oxidative gases, the hydroionization cells including an ultraviolet light source and a multi-metallic catalytic target comprising more than one type of metal; and
a transport system configured and arranged to transport the meat product from the first treatment station to the second treatment station.

10. A ground meat processing system with combined liquid and gaseous antimicrobial interventions comprising:
a first liquid antimicrobial treatment station adapted to apply an antimicrobial solution comprising an antimicrobial agent to a meat product comprised of meat trimmings having a first size;
a first meat shredding or grinding apparatus operable to reduce the size of the meat trimmings to define a first ground bulk meat product;
a second gaseous antimicrobial treatment station comprising a plurality of photohydroionization cells operable to generate ultraviolet light and advanced oxidative gases, the photohydroionization cells being positioned and arranged to expose the first bulk meat product to the ultraviolet light and advanced oxidative gases; and
a transport system operable to transport the meat product through the first and second treatment stations.

11. The system of claim 10, wherein the photohydroionization cells comprise an ultraviolet light source and a multi-metallic catalytic target positioned to receive ultraviolet energy from the light source, the catalytic target being comprised of more than one type of metal.

12. The system of claim 10, wherein the advanced oxidation gases include ozone, Hydroxyl Radicals, Super Oxide Ions, Ozonide Ions, Hydroxides, and Hydro Peroxide.

13. A method for reducing microbial populations on food products by combining liquid and gaseous antimicrobial treatments, the method comprising:
applying a first aqueous solution comprising an antimicrobial agent to a food product;
energizing a germicidal ultraviolet light source proximate the food product; and
forming a gaseous antimicrobial oxidative environment near the food product, the oxidative environment and ultraviolet light being operable to inactivate microbes on the food product.

14. The method of claim 13, wherein the energizing step includes striking a multi-metallic catalytic target containing a hydrophilic material and more than one type of metal with the ultraviolet light to form the gaseous oxidative environment.

15. The method of claim 13, wherein the gaseous antimicrobial oxidative environment comprises ozone, Hydroxyl Radicals, Super Oxide Ions, Ozonide Ions, Hydroxides, and Hydro Peroxide.

16. The method of claim 13, wherein the food product is meat.

17. A method for reducing microbial populations on ground meat products by combining liquid and gaseous antimicrobial treatments, the method comprising:
applying a first aqueous solution comprising an antimicrobial agent to meat trimmings;
reducing the size of the meat trimmings to define a first ground bulk meat product;
energizing a plurality of photohydroionization cells comprising an ultraviolet light source; and
forming an gaseous antimicrobial oxidative environment proximate the first ground bulk meat product for inactivating microbes on the meat product.

18. The method of claim 17, wherein the energizing step includes striking a multi-metallic catalytic target containing a hydrophilic material and more than one type of metal with the ultraviolet light to form the gaseous oxidative environment.

19. The method of claim 17, wherein the gaseous antimicrobial oxidative environment comprises ozone, Hydroxyl Radicals, Super Oxide Ions, Ozonide Ions, Hydroxides, and Hydro Peroxide.

20. The method of claim 17, further comprising a step of applying a second aqueous solution comprising an antimicrobial agent to the meat trimmings before the reducing step.
